(19) United States
(12) Patent Application Publication
(10) Pub. No.: US 2008/0166453 A1
(43) Pub. Date: Jul. 10, 2008

(54) LOW-CALORIE, NO LAXATION BULKING SYSTEM

(75) Inventors: George E. Steele, Fort Worth, TX (US); Donna Henry, Paris, TX (US)

Correspondence Address: FULBRIGHT & JAWORSKI L.L.P, 2200 ROSS AVENUE, SUITE 2800, DALLAS, TX, 75201-2784, US

(73) Assignee: Remington Direct LP, Fort Worth, TX (US)

(21) Appl. No.: 12/037,813

(22) Filed: Feb. 26, 2008

Related U.S. Application Data
(63) Continuation-in-part of application No. 11/828,915, filed on Jul. 26, 2007.
(60) Provisional application No. 60/833,551, filed on Jul. 26, 2006.

(51) Int. Cl. A23L 1/236; A23L 1/29; A23P 1/10; A23G 3/36

(52) U.S. Cl. 426/72; 426/548; 426/89; 426/104; 426/506; 426/321

(57) ABSTRACT

A low-calorie, no laxation bulking system and a method for preparation of same is disclosed. Erithritol and at least one gum are combined to form a dry-blended mixture. The dry-blended mixture is added to water, forming a first mix, and the first mix is heated to a first temperature. A first liquid mixture comprising modified polydextrose is formed. The first liquid mixture is added to the first mix to form a second mix, and the second mix is heated to a second temperature. A second liquid mixture comprising at least one acid is added to the second mix, and the resultant solution is maintained in a predetermined temperature range. The resultant solution is then preferably stirred constantly and held in a kettle or mixing tank for panning or molding as desired.

### CROSS-REFERENCE TO RELATED APPLICATIONS

The present application is a continuation-in-part of co-pending, commonly assigned, U.S. patent application Ser. No. 11/828,915, entitled “No Laxation, Low Flatulence Bulking System,” filed Jul. 26, 2007, which itself claims priority to co-pending U.S. Provisional Patent Application No. 60/833,551, entitled “No Laxation Bulking System,” filed Jul. 26, 2006, and is related to co-pending U.S. patent application Ser. No. 11/828,950, entitled “No Laxation Bulking System,” filed Jul. 26, 2007, the disclosures of which are hereby incorporated herein by reference.

### TECHNICAL FIELD

The present invention relates generally to low-calorie, no laxation bulking systems and more particularly, to a system and method of forming a low-calorie, no laxation bulking system in the form of a soft candy product for human ingestion.

### BACKGROUND OF THE INVENTION

In recent years, controlling sugar, calories, fat and carbohydrates in the human diet has become more of a concern. Many humans desire to control these items to satisfy special dietary needs, i.e., individuals suffering from diabetes or other health problems. Other humans are attempting to eat more healthfully as a preventative measure and/or so as to address weight loss or maintenance concerns.

Regardless what type of dietary needs a person has, typically snack foods are part of such diet. For example, those attempting to lose weight may ingest a number of small meals during the day, some of those meals being snack foods. Similarly, diabetics may require snack foods during the day in order to maintain a proper blood sugar level. Snack foods also may be eaten in order to provide energy or to deliver vitamins to the body. Thus, most humans incorporate snack foods into their diet but the desire is to have a more healthful snack food. To prevent hunger there exists a need for a food item to act as a low calorie stomach fill, this food item should be able to be consumed in large quantities to satiate hunger with no resultant weight gain.

Many consider confectionery items, such as candies, to be snack foods. In the past, candies have not been considered to be very healthy. In recent years, however, many confectioners begun developing ways to make more healthful confectionery items, such as sugar-free candies. The confectionery industry has been developed around the properties of one ingredient—sucrose—and thus, when developing sugar-free candies, the desire is to find substitutes for sucrose that most closely mirror the properties, particularly the taste, of sucrose. There also is a need for a sugar-free confectionery snack that is low calorie as sugar-free confections typically are as caloric or only slightly less caloric than sucrose-based confectionery counterparts.

Polyols are often used as substitutes for sucrose in the manufacture of sugar-free confectionery items. Polyols typically used in sugar-free confectionery items include sorbitol, maltitol, lactitol, isomalt and polydextrose. Maltitol, which is produced by hydrogenating maltose in the form of a pure maltose glucose syrup, is believed to most closely resemble the properties of sucrose in that, like sucrose, maltitol is a disaccharide. However, the use of polyols, particularly maltitol, in these sugar-free confectionery items can often be disadvantageous due to the laxative and flatulence-related effects that these polyols produce. The laxative and flatulence-related effects are osmotic in origin given that the unabsorbed material upsets the osmotic balance within the intestinal system, and the consequences can be unpleasant for many who ingest sugar-free confectionery items containing such polyols. Thus, there exists a need for a bulking system, such as in a soft candy product, that is sugar-free and low-calorie while avoiding the laxation and flatulence-related effects typically encountered with food items that incorporate polyols.

Sugar-free confectionery products are typically manufactured in a manner similar to that of sugar-containing confectionery products. In the case of soft candy products, the amount of time needed for the products to set prior to packaging and distribution is significant given that the formulation takes a long time to dry and cool. For example, when a confectionery item containing maltitol syrup is formed, typically it takes at least one to two days before the confectionery item has sufficiently dried and cooled. Thus, there exists a need for a method of forming a bulking system that sets, dries and cools in a shorter period of time. There also exists a need for a method of packaging a bulking system in a manner that maintains the form and quality of the bulking system.

### BRIEF SUMMARY OF THE INVENTION

The present invention is directed to a method for producing a low-calorie, no taxation bulking system. A base of water is provided in a mixing kettle or tank. A first set of ingredients comprising erithritol and at least one gum is blended into the water and then heated to a first temperature. A first liquid mixture of modified polydextrose is preferably then added, and the combination is heated to a second temperature. The heat is maintained within a predetermined temperature range, and a second liquid mixture comprised of at least one acid is added to the solution. The resultant solution is then preferably stirred constantly and held in a kettle or mixing tank for panning or molding as desired. Embodiments of the invention further comprise adding food-grade plasticizing) agents and/or waxes, hydrogenated starch hydrolysate (HSH), dimethicone, activators, gelatin and/or active ingredients as components of the low-calorie, no taxation bulking system. Other additives also may preferably include flavors, colors, fruit concentrates and/or sucralose or another high intensity sweetener. Preservatives may be incorporated into the bulking system by addition to water prior to introducing the dry-blended mixture into the water.

Another embodiment of the invention is a low-calorie, no taxation bulking system. The bulking system is preferably comprised of water, a dry-blended mixture comprising erithritol and at least one glum, a first liquid mixture of modified polydextrose, and a second liquid mixture comprising at least one acid. The dry-blended mixture is added to water present in the mixing kettle or tank to form a first mix, and the first mix is heated to a predetermined temperature range. The first liquid mixture is added to the first mix and heated. The solution is maintained a predetermined temperature range, and a second liquid mixture is added. The resultant solution is then preferably stirred constantly and held in a kettle or mixing tank for panning or molding as desired.

Further embodiments of the present invention are low-calorie, no taxation soft candy products. The soft candy product preferably is comprised of a dry-blended mixture, wherein the first dry-blended mixture comprises 9 to 50% erithritol and 0 to 5% of at least one gum. A first liquid mixture comprising 0 to 20% modified polydextrose and a second liquid mixture comprising 0 to 5% of at least one acid also form part of the low-calorie, no taxation soft candy product contemplated by the present invention. The dry-blended mixture is added to water to form a first mix, and the first mix is heated to a first temperature. A first liquid mixture is added to the first mix and heated. The heat is maintained in a predetermined temperature range, and the second Liquid mixture is added. The resultant solution is then preferably stirred constantly and held in a kettle or mixing tank for panning or molding as desired.

The foregoing has outlined rather broadly the features and technical advantages of the present invention in order that the detailed description of the invention that follows may be better understood. Additional features and advantages of the invention will be described hereinafter which loon the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### DETAILED DESCRIPTION OF THE INVENTION

The desire is to achieve a stable matrix using a bulking agent. This is achieved by using a sugar alcohol, such as erithritol, as well as a modified polydextrose, such as Litesse Ultra liquid, having high fiber content. The finished product includes high levels of erithritol dissolved in water and stabilized by hydrocolloids. The finished product is preferably zero sugar and low calorie providing for no Taxation and reduced flatulence properties upon ingestion. A low-calorie, no laxation bulking system, such as a soft candy product, is preferably formed using a dry-blended mixture of erithritol and gums added to water to form a first mix. The first mix is heated to a first temperature, and a first liquid mixture of modified polydextrose is then added to the first mix while continuing to apply heat. The temperature is maintained in a predetermined temperature range, and a second liquid mixture comprised of at least one acid is added to the solution. The resultant solution is then preferably stinted constantly and held in the kettle or mixing tank for panning or molding as desired. The product also may be extruded. The finished product is then plated or molded into sprayed or prepared pans. Cooling occurs, preferably for one to two hours, and then the resulting product is depanned and sanding or other finishing processes may preferably occur.

Pectins are often used for making confectionery items. However, typically they have not been used in conjunction with gummy-like and/or soft candy bulking systems. This is due to the problem that if the pH does not fall within a specific range, the system formed may be unstable and may not set properly. However, in the present invention, a low methoxyl (LM) pectin, such as pectin LM/CP Kelco, is preferably used and is chosen for its ability to work with gellan gums in setting a firm gummy-like candy product. In some embodiments of the present invention, pectin amid AF020 also may be utilized because of its specific ability to work with the other components of the bulking system in setting the bulking system without stickiness being present in the product when it is placed in combination with sugar alcohols or polyols.

Gums, such as gellan gums, are preferably used in forming the bulking system contemplated by the present invention so as to give the resultant gummy-like candy product, for example, its elastic texture. Preferable gellan gums include Kelcogel LT100 gellan gum and gellan gum F as they are texture modifiers and stabilizers, and provide for an elastic gel texture when used in food-related applications. Other gums, including, but not necessarily limited to, carrageenan iota gum, carrageenan, gum Arabic, Xanthan, Karaya, Agar, locust beat/carob bean, carboxy methyl cellulose (CMC), and tragancanth also preferably may be utilized in conjunction with gellan gums.

Erithritol is incorporated into the bulking system of the present invention. Erithritol is a polyol that acts as a novel bulk sweetener and has a caloric value close to zero (0.2 kcal/g). It is the only polyol presently known that has been shown not to cause laxation effects when incorporated into sugar-free edible items. Erithritol is believed to avoid this laxative effect because it is excreted through the kidneys, and as it has a low molecular weight, more than 90% is absorbed in the small intestine. This fraction is not metabolized and is excreted unchanged through the urine. Thus, it is shown to have the highest digestive tolerance of the polyols as studies have shown that adults ingesting up to 1 g of erithritol per day per kilogram of body weight do not show any gastrointestinal effects. Further, while conventional industry wisdom states that erithritol cannot be used above 8% volume in a stable bulking system because crystallization would occur to the point that the bulking system fails, a much larger volume of erithritol (over 8%) is utilized in the bulking system according to embodiments of the present invention. Fine erithritol granules are preferably used in the bulking system contemplated by the present invention. Granules, as opposed to a powder form, are preferably used as the powder version typically does not retain enough water for absorption. This lack of water retention may affect the process to the extent that setting of the bulking system may be hindered or even prevented. However, it should be appreciated that other forms of erithritol may be used without departing from the objects of the present invention. For example, erithritol in a syrup form may preferably be substituted for granular erithritol; however, a reduction in the amount of water used in the hulking system may be required and processing times likely would be altered. In other embodiments, less finely granulated erithritol or powdered erithritol also may be utilized.

Prior to initiation of the bulking system manufacturing process, erithritol and at least one gum (including, but not necessarily limited to, carrageenan iota gum, carrageenan, gum Arabic, Xanthan, Karaya, Agar, locust bean/carob bean, carboxy methyl cellulose (CMC), and tragancanth and combinations thereof) are combined to form a dry-blended mixture. Further, if pectins, such as LM pectin, are utilized, these pectins also form part of the dry-blended mixture. This dry-blended mixture is preferably prepared as a pre-blend prior to initiation of the bulking system blending process, and the pre-blend should be held separately from the other components of the bulking system until the appointed time for blending. However, in other embodiments, the dry-blended mixture may be prepared at the time of initiating the bulking system manufacturing process. Additionally, no heat should be applied to the dry-blended mixture prior to initiation of the blending process.

In a first step of the blending process, water is preferably metered or weighed into a mixing kettle or tank, and the water may be preferably measured by metering the water into the tank or mixing kettle at the time when it is needed in the blending process. In another embodiment of the present invention, the water may be weighed into a container, set aside, and then added to the mixing kettle or tank at a time when the blending process is initiated. No heat is preferably applied to the water when it is weighed or metered into the mixing kettle or tank as the water should preferably remain at room temperature so as to avoid adverse effects in the mixing and dispersion of the components of the hulking system.

The dry-blended mixture of erithritol and at least one gum is then added to the water under high shear, preferably using a lightning mixer or its equivalent, and blended until even dispersement is achieved. In an embodiment of the present invention, approximately 10-15 minutes may be needed to achieve the desired dispersement of the first mix, although it should be appreciated that the time needed for dispersement may vary depending on the volume of the mix being prepared. If a preservative is utilized in the bulking system (as described below), the dry-blended mixture is added to the water following blending of the preservatives into the water.

It should be appreciated that in some embodiments of the present invention, if pectins are used, pectins may be added to the water in a step separate from and prior to addition of a dry-blended mixture of erithritol and gums. If such an intermediate step is employed, pectin may preferably be added to the water under medium agitation until dispersed in the water. If a preservative is utilized in the bulking system (as described below), pectin is preferably added to the water in the mixing kettle or tank following blending of the preservatives into the water. However, again, pectins also may be incorporated into the dry-blended mixture.

The hulking system is preferably comprised of 9 to 50% erithritol, and 0 to 5% gums. Preferably, however, erithritol comprises approximately 20 to 30% of the bulking system. In embodiments containing pectin, the bulking system comprises 0 to 5% low methoxyl pectin and preferably 0-1% pectin. As the amounts and percentages of erithritol, pectin, and/or gums change due to scaling of the manufacturing process, it should be appreciated that the time required to fully blend these components also may change.

Gelatins are often used for making confectionery items. Gelatins produced by acid hydrolysis are referred to as type A, whereas gelatins produced by alkaline hydrolysis are typically referred to as type B. The pH of type A gelatin is typically higher than the pH of type B gelatin (6.3-9.5 versus 4.5-5.2). Type A gelatins are preferably used for forming low-calorie, no laxation bulking systems contemplated by the present invention. Gelatins are typically not stable in acid, and thus any addition of acid should be as late as possible in the manufacturing process. Specifically, a gelatin type A 250 bloom is preferred. This gelatin has been selected based on having the specific ability to allow gelatin to set at a lower temperature (i.e., reduce the amount of time for setting as well as the temperature at which setting occurs) when used in combination with other ingredients as described and to produce a film soft or hard candy product. Further, type A gelatin has the ability to work in conjunction with low methoxyl pectin and gellan gums. If it is desirable to use gelatins in the formulation of a bulking system according to embodiments of the present invention, gelatins are preferably incorporated into the dry-blended mixture previously described.

In some embodiments of the present invention, preservatives, such as a blend of potassium sorbate and sodium hexametaphosphate (Glass H), may preferably be added to the water in the mixing kettle or tank under low agitation until dissolved, before addition of the dry-blended mixture to water occurs. Sodium hexametaphosphate and potassium sorbate are preservatives used to keep the bulking system fresh and to prevent mold from forming in the product. A dry blend of preservatives is preferably prepared for dissolution in water in the mixing kettle or tank before the dry-blended mixture of erithritol at least one gum is combined with water in the tank. It should be appreciated that if preservatives are incorporated into the bulking system of the present invention, no heat should be applied when the preservatives are blended into the water. These preservatives are regulated for use at approximately 0.1%.

When even dispersement of the dry-blended mixture and water (and preservatives, if utilized) is achieved, heat may then be applied to the resultant mixture in order to speed up the dispersion and blending process. Heat is preferably applied to the mixture until the temperature of the mixture reaches a first temperature of at least 190 degrees Fahrenheit under continuous agitation. When this first temperature is reached, it should be maintained for a period of time dependent on the type of equipment and amount of ingredients being used; however, in a preferred embodiment, it is preferably maintained for approximately two minutes.

A first liquid mixture of modified polydextrose is then preferably added to the mixture, and, under continued, agitation, the mixture is heated until a second temperature is reached. The first liquid mixture may be added to the first mix while the mixture still undergoes continuous agitation. The second temperature is preferably approximately 210 degrees Fahrenheit. The first liquid mixture of modified polydextrose is preferably weighed and held in a container separate from other components of the bulking system until at such time it is to be added during, the blending process.

A preferred modified polydextrose for use is Litesse. Litesse is known as a specialty carbohydrate (polydextrose) that replaces sugar and fat while improving flavor, texture and mouthfeel in a variety of applications. It is low glycemic and thus suitable for consumers seeking low impact carbohydrates. Further, Litesse is water soluble and is used as a bulking agent to make a variety of items lower in fat, calories and sugar-free while also high in fiber and having a good taste. The liquid formulation of Litesse (Litesse Ultra liquid) is preferable to use because there is typically less water present in the formulation, and it presents a clean taste with mildly sweet flavor. The percentage of Litesse Ultra liquid preferably present in the formulation can range from 0 to 20% of the resultant bulking system. This low percentage range for Litesse Ultra liquid is achieved by incorporating it with gellan gum and/or low methoxyl pectins to produce a firm candy product. It should be appreciated however that lower percentages of Litesse Ultra liquid may be used if another form of Litesse (such as Litesse II) is also used in the composition and/or a hydrogenated starch hydrolysate (HSH) also is employed. It also should be appreciated that a modified polydextrose other than Litesse may be employed without departing from the objects of the present invention.

Upon reaching the second temperature, a second liquid mixture of acids, flavors, sucralose, fruit concentrate, and colors is preferably added to the existing mixture under medium to medium high agitation. This second liquid mixture is preferably formed by weighing acids, colors, flavors, sucralose and fruit concentrate together in a container separate from the mixing kettle or tank. Each of the components of the second liquid mixture are preferably employed such that each component forms approximately 0 to 6% of the resultant bulking system. The second liquid mixture is blended until all components are mixed and the color is well dispersed. When the second liquid mixture is added to the mixture existing in the mixing kettle or tank, the heating temperature is preferably maintained within a predetermined temperature range of approximately 200-220 degrees Fahrenheit. It should be appreciated that the mixture may undergo thinning while heat is applied, but blending and heating should occur until the temperature may be maintained in the 200-220 degree Fahrenheit range.

Different acids may be utilized depending on the type of finished product desired. Acids employed may include, but are not necessarily limited to, ascorbic acid, fumaric acid, malic acid, and sodium acid sulfate (also known as phase). Malic acid is preferably used when a fruit-flavored product is formulated. Malic acid has characteristics that allow for setting the bulking system at low temperature ranges. Ascorbic acid and sodium acid sulfate (also known as pHase) also are preferably used along with fumaric acid to set the gel formed as well as to retard or reduce flatulence. It should be appreciated that the amount of acid used in the second liquid mixture may comprise anywhere from 0 to 5% of the resultant bulking system. Preferably, the acids comprise 1 to 2% of the bulking system and are utilized, in part, to activate the gels in the bulking system to set the formation into a soft candy product. Although only at least one acid is required to form the second liquid mixture, it should be appreciated that at this step, color, flavors, fruit concentrate, and sucralose sweetener or some other high intensity sweetener may preferably be blended with the at least one acid to form the second liquid mixture.

Preferred flavors may be fruit flavors, although other flavors may be added and/or substituted without departing from the object of the invention, such as a chocolate flavor as will later be described. Regardless what flavors are utilized in forming the second liquid mixture, they are preferably concentrated and most often are in liquid form. Preferably the flavor level is at 2% or below. It should be appreciated that when concentrations of the flavor fall below this percentage, off-flavors begin to show up in the finished bulking system due to the carriers in the flavors and the reduction of the other ingredients to make a place for the carriers for flavors.

For added flavor in fruit-flavored bulking systems, a fruit concentrate with essence returned is preferably utilized. Fruit concentrate has the functional attributes of adding particle fibrous pieces and pectin to the bulking system and also is desirable because of its high refractive index. For example, strawberry fruit puree concentrate with essence returned is a preferable fruit concentrate as it is low in calories and is 28 degree brix. It also has the essence returned allowing more flavor for a smaller amount of usage. This fruit concentrate typically comprises less than 1% of the resultant bulking system although it can range from 0 to 5% of the composition. In a preferred embodiment, a pear puree concentrate with essence returned is utilized to allow other flavor profiles to be incorporated into the resultant bulking system.

Dried sucralose sweetener is preferably used for additional flavoring and comprises 0 to 5% of the bulking system, although preferably sucralose comprises less than 1% of the bulking system. A dried form of sucralose is preferred in that the liquid form has polyesters/polysorbates that may adversely affect the resulting bulking system. Various colors can be used depending on the color desired for the bulking system, and the color typically comprises less than 0.01. % of the bulking system. When at least one acid, color, flavors, sucralose, water and fruit concentrate are combined to preferably form the second liquid mixture, the components are mixed until the color is well dispersed. The second liquid mixture is then set aside.

Activators may preferably be used in embodiments of the present invention. Activators may include potassium or calcium sources, including but not necessarily limited to, calcium malate, tri-magnesium citrate, calcium citrate, calcium lactate, calcium potassium phosphate citrate, and potassium citrate. Preferably activators are employed such that they form 0 to 6% of the resultant bulking system. If such activators are used, activators should be held for addition to the mixture until after the second liquid mixture of at least one acid is incorporated into the mixture as previously described. If a potassium or calcium source is utilized as an activator, this activator should preferably be added to the mixture under high agitation after the second liquid mixture is added and the predetermined temperature range of approximately 200-220 degrees Fahrenheit has been reached.

If an active ingredient is to be incorporated into the bulking system, it should be weighed and held in a separate container until time for blending with the components of the bulking system. An active ingredient should preferably be blended into the mix prior to addition of the second liquid mixture as the mixture will not have been subjected to a large amount of heat at this stage in the blending process. The active ingredient(s) should preferably be added under high agitation, and upon addition, the mixture should be stirred constantly during the blending process in order to ensure even dispersement of the mixture or at least to ensure that the solid portions of the mixture are dispersed. An active ingredient preferably should be added while no heat is being applied to the mixing kettle or tank.

Active ingredients include, but are not limited to: vitamins; minerals; mineral salts; caffeine; pheobromine; central nervous system stimulants; amino acids; appetite suppressants; SSRIs; MAOI's; electrolytes; hydroxy citric acid; 5-hydroxy tryptophan (5-HTP); NSAids including acetaminophen, ibuprophen, aspirin or salicylic acid; glycerol; weight loss ingredients; and over-the-counter (OTC) medicines including, but not limited to, allergy/sinus medicines (such as diphenhydramine HCl), cough suppressants (such as dextromephorphan HBr), antihistamines, and nasal decongestants (such as pseudoephedrine HCl) may be added following addition of HSH, if desirable. These active ingredients, if incorporated into the bulking system, typically comprise approximately 3-4% of the resultant bulking system but may range from 0 to 7%. This system for delivery of active ingredients is useful for children as well as adults who would express a preference for ingesting these active ingredients in a soft candy form which may have a more pleasant taste and may be more enjoyable to consume than an active ingredient in pill form, for example.

In some embodiments of the present invention, hydrogenated starch hydrolysate (HSH) may be employed as a component of the bulking system. A hydrogenated starch hydrolysate, such as FISH Stabilite SD30, may preferably be used as a bulking agent. SD30 is a hydrogenated starch hydrolysate in spray-dried form that is a low-sweetness powder and can be dissolved in water to produce clear; noncrystallizing syrups.

If HSH is desirable to be used, it may be incorporated into the dry-blended mixture. When it is initially combined with water, the water must be maintained at room temperature in order to ensure adequate mixing and dispersement of HSH in solution. HSH should be weighed and held in a separate container and then mixed into the dry-blended mixture. Should HSH be included as part of the bulking system, it preferably comprises 0 to 4% of the resultant bulking system.

Dimethicone is also known as polydimethylsiloxane (PDMS) and is recognized for its unusual rheological properties. Dimethicone, an ingredient having anti-gas properties, is preferably blended in after addition of the dry-blended mixture. Similar to the weighing of active ingredients, dimethicone or other ingredients having anti-gas properties should be weighed and held in a separate container for later use in the manufacturing process. Dimethicone should be added to the mixing tank under continuous agitation and stilted at a slow to moderate speed to disperse the solid portions of the mixture without thickening the mixture. It is preferable that it be added prior to applying heat to the mixture.

A food-grade plasticizing agent may preferably be incorporated into the bulking system. Several types of food-grade plasticizing agents may be used. In one embodiment of the present invention, in an intermediate step following addition of the dry-blended mixture to water, a plasticizing agent, such as paraffin wax, carnuba wax or bees wax, may be weighed and melted in a separate container. Preferably, the wax will melt at approximately 200-212 decrees Fahrenheit. Paraffin wax, if used, preferably comprises approximately 0 to 20% of the resultant bulking system. If carnuba wax is used, it preferably comprises 0 to 60% of the resultant bulking system. This melted wax should be held for later addition in the bulking manufacturing process. In another embodiment of the present invention, a food-grade resin such as, but not limited to, shellac resin, may be added in a separate step prior to addition of the second liquid mixture as has been described, and this food-grade resin preferably comprises 0 to 20% of the resultant bulking system. In a further embodiment of the present invention, a food-grade gum, such as, but not limited to, mastic gum and pullulan gum, may be incorporated into the di-y-blended mixture, and this food-grade gum preferably comprises 0 to 20% of the resultant bulking system.

A plasticizing agent, such as melted paraffin wax or carnuba wax, may preferably be added when the first temperature has been reached. Such an addition should be made under constant slow to medium agitation, however, if other food-grade plasticizing agents, such as food-grade resins or food-grade gums, are to be utilized, these plasticizing agents are preferably added separately prior to addition of the second liquid mixture. After maintaining the first temperature for a period of time and, if a wax plasticizing agent is used, once the combination of ingredients including the melted max has fully blended, addition of other components of the bulking system, including addition of the second liquid mixture, preferably occurs.

When the predetermined temperature range is reached following addition of the second liquid mixture, the bulking system is ready to be panned, plated or molded. It should be appreciated that the bulking system should be plated or molded as quickly as possible once the predetermined temperature range is reached as it will typically begin to gel upon cooling. Further, once the composition has been plated or molded, it should be allowed to cool before depanning should be performed. Alternatively, the resultant composition may be extruded and allowed to cool.

If a panning process is employed, the bulking system should be panned quickly as the temperature will begin to reduce during the panning process, and it is preferable that the bulking system be placed in the pan when the temperature is in the range of 170-200 degrees Fahrenheit. The panning process involves depositing the bulking system into a starch mold, and the bulking system should preferably remain in the starch mold for approximately one-half hour up to approximately three hours before de-panning. It should be appreciated that the bulking system will preferably gel quickly upon dispersement in the starch mold. It also should be appreciated that the thickness of the panned layer can vary depending on the texture and thickness desired for the finished product. As an example, if the bulking system is panned in a thicker manner, less steam time may be required, resulting in a finished product that is thicker with less of a crusty outside layer.

The process described above used to make the novel bulking system is devised so as to produce a product that will plate, mold and set faster than prior soft or hard candy products. Temperatures used when the product is at the stage for heating and molding should be kept to a maximum of 195-200 degrees Fahrenheit. Preferably, the candy product should not remain in the mixing container for more than two hours prior to heating or molding. Once the healing steps are complete, the product should preferably be molded immediately and not left to stand in the mixing container or in packaging equipment.

It is preferable that the setting temperature be maintained at approximately 170-200 degrees Fahrenheit. This setting temperature is important for loading active ingredients such as vitamins. over-the-counter (OTC) drugs, as well as acetaminophens (or NSAids) because high heat exposure potentially will destroy these active ingredients. The setting temperatures are quite cool in that the finished product gels and sets below 180 degrees Fahrenheit which is below the melting point of every NSAid currently on the market.

When the bulking system has been panned for a predetermined range of time, the bulking system is then preferably de-panned. It should be appreciated that the bulking system will likely absorb some of the starch on its outer coating during the panning process, and thus, to the extent starch remains on the bulking system after de-panning, the starch should preferably be removed from the bulking system.

Upon completion of a de-panning process, the bulking system then proceeds into a sanding process. The bulking system is removed from the panning, and any remaining starch is removed from the bulking system. The bulking system is then preferably sent through a steam tunnel where the bulking system is exposed to steam for a brief period of time as is known in the art. It should be appreciated that the bulking system may remain in the steam tunnel for varied amounts of time depending on the texture desired for the bulking system (i.e., more or less crust). The bulking system then is preferably deposited into a container/tumbler that preferably contains a blend of granulated erithritol and calcium silicate and it is tumbled. The erithritol-calcium silicate blend is preferably comprised of 0.5%-2% calcium silicate with the rest comprised of erithritol. Use of calcium silicate is preferable in that it aids the drying process and allows for extended use of erithritol in the sanding process. It also is believed to interact with activators, such as tri magnesium citrate, if present in the bulking system, such that the tri magnesium citrate precipitates out during the sanding process to form a crust-like texture on the bulking system. The bulking system is then sifted out of the erithritol/calcium silicate mixture and packaged for distribution as described below.

Upon depanning or extruding and sanding, the bulking system is preferably packaged in a container, such as a sealable bag, and a nitrogen drop or flush is preferably introduced into the container. This nitrogen introduction is beneficial to maintaining the form and quality of the resultant product in that the nitrogen preferably stops an oxidation process from taking place, allowing the resultant bulking system to retain the flavors and colors in the form that they were introduced into the bulking system. Further, as erithritol comprises a relatively large percentage of the resultant product, introduction of nitrogen preferably retards its crystallization as embodiments of the bulking system which are devoid of nitrogen may only be comprised of as little as one-fourth the percentage of erithritol found in the preferred embodiment of the present invention. In addition, nitrogen preferably acts as a thermal insulator to slow down any melting that the resultant product may undergo. This is important because typically sugar-free bulking systems have had a tendency to melt at lower temperatures than are desirable. Introduction of nitro-en into the sealable container holding the bulking system preferably counteracts such tendency.

Finished products can include weight loss snacks and bars that can be either extruded or molded. When a reference is made to extrusion, this is usually when the product is squirted out and then cut, such as when licorice rope or bars are made. When molded, such as molding that takes place with gummy bears, the molds are pressed into cornstarch, the melted ingredients are poured in, and then are finished with a carnouba wax in a panning process. Weight loss/energy/meal replacement bars are extruded. In order to make a bulking system extrudable, one adds flour or a flour analog. Preferably, the flour or flour analog comprises 0 to 15% of the resultant bulking system. A type of flour that may be used is Konjac flour which has a high fiber content (such as 95%). The use of rice flour or starch are other possibilities. The preference is to use a flour that has no glutens. A soy milk powder also may be preferably included with the flour or flour analog to form an extrudable finished product, and if soy milk powder is used, it also preferably comprises 0 to 15% of the resultant bulking system.

Different types of finished product applications formed by the method described in the present invention include low-calorie gummy-like products, non-rolled fruit snacks, gummy-like products loaded with vitamins, energy-producing gummy-like products, gummy-like products for weight loss, chocolate chews, fruit extruded bar or rope/twist, as well as hard candies, bars, licorice ropes or analogs, fruit snacks, and rolled fruit snacks. A hard candy coating also may be applied to the bulking system. To form a hard candy coating, the centers of the candy would be deposited into starch molds, and the sanding process described with respect to the soft candy would be replaced with a panning process so as to shellac the candy with a hard coating which is preferably a mixture of sugar alcohols, colors, along with a wax or resin base. Rolled fruit snacks are made by spraying a thin layer of mixed, molten liquid onto wax paper or some other paperlike substrate, and one side of the rolled fruit snack may preferably undergo sanding. Rolled fruit snacks or other fruit snack products in the context of the described bulking system invention, contain additionally a low dextrose equivalent (low DE) fruit concentrate with returned fruit essence. While these types of bulking systems are specifically identified, it should be appreciated that other bulking systems may be produced by the process discussed in the context of this invention.

In one embodiment of the present invention, a soft candy product having a fruit flavor is formed. Erithritol, pectin (such as LM-101 AS/Kelco), gellan gum LT100, gellan gum F/Kelco gel, carageenan iota, and gum Arabic/colony are combined to form a dry-blended mixture. Erithritol granules preferably comprise approximately 20-30% of the resultant composition, pectin preferably comprises approximately 0.5-2% of the resultant composition, and gums preferably comprise approximately 1 to 5% of the resultant composition. A first liquid mixture is preferably comprised of Litesse ultra liquid Litesse ultra liquid comprises approximately 0-5% of the resultant bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 1-3% of the resultant bulking system, and the remaining components of the second liquid mixture comprise approximately 1-2% of the resultant composition.

Preservatives (such as Glass H and potassium sorbate) are added to water in the mixing tank and then dissolved under low agitation without heat. These preservatives preferably form approximately 0.1% of the resulting composition. The dr-blended mixture is preferably added to the preservative/water mixture under high shear/agitation and blended until no lumps are visible. This blending process preferably continues for approximately 10-15 minutes depending on the volume of the mixture. Heat may then be applied once the dry-blended mixture is added, and the mixture may preferably be heated to a first temperature of at least 190 degrees Fahrenheit.

When this first temperature is reached and even dispersement is achieved, a first liquid mixture of Litesse ultra liquid is then added to the blend under continued agitation. The temperature of the mixture is then preferably increased to a second temperature of approximately 210 degrees Fahrenheit. A second liquid mixture of acids, flavor, sucralose, fruit concentrate and color is then preferably added under medium high agitation. It should be appreciated that the mixture will undergo thinning in texture. Agitation of the mixture should preferably continue until the temperature of the mixture reaches a predetermined temperature range of approximately 200-220 degrees Fahrenheit. When this predetermined temperature range has been reached, the composition that forms is held for later panning or molding.

In this embodiment of the present invention, calcium lactate is preferably utilized as an activator. The activators preferably for less than 0.6% of the resultant combination. The activator(s) may be added under high agitation after the predetermined temperature range has been reached and after the second liquid mixture has been added. However, the activator(s) need to be added before the composition is panned.

Variations of the above described embodiment may be formed wherein, for example, by addition of gelatin, plasticizing agents, dimethicone, active ingredients or HSH as previously described. The dry-blended mixture as well as the first and second liquid mixtures remain at similar percentages of the resultant soft candy composition even with addition of any or all of the above-described additional ingredients.

In a second embodiment of the present invention, a soft candy product is formed without the inclusion of gelatin or pectin in the dry-blended mixture. Erithritol, gellan gum LT 100, gellan gum F/Kelco gel and gum arabic spray dried/colony are combined to form a dry-blended mixture. Dimethicone is preferably added to a mixture of water, preservatives and the dry-blended mixture following addition of the dry-blended mixture. Similar to the first embodiment described, erithritol granules preferably comprise 15-30% of the resultant composition and gums preferably comprise approximately 0 to 5% of the resultant composition. A first liquid mixture is preferably comprised of Litesse ultra liquid which comprises approximately 0 to 5% of the resultant composition and clarified rice syrup which comprises approximately 0-3% of the resultant composition. Clarified rice syrup may preferably be incorporated into the bulking system as an additional binding agent when gelatin and/or pectin are absent from the bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 1-3% of the resultant bulking system, and the remaining components of the second liquid mixture comprise approximately 1-2% of the resultant composition. Beta cyclodextrin then may preferably be added to the mixture following addition of the second liquid mixture. Other than alterations to the composition and process as described above, the process of forming the bulking system with respect to this embodiment of the present invention proceeds in the manner described above with respect to the first embodiment. In the present embodiment, calcium lactate is not used as an activator; however, it should be appreciated that an activator could preferably be incorporated into the formulation without departing from the objects of the present invention. Again, variations of the above-described embodiment may be formed by adding other active ingredients, plasticizing agents or HSH. The dry-blended mixture as well as the first and second liquid mixtures remain at the same percentages of the resultant soft candy composition even with addition of any or all of the above-described additional ingredients.

In a third embodiment of the present invention, a soft candy product is formed wherein gelatin is incorporated into the dry-blended mixture while pectin is excluded. Specifically, erithritol, gellan gum LT 100, gellan gum F/Kelco gel and gelatin type A 250 bloom are combined to form a dry-blended mixture. Similar to the above-described embodiments, erithritol granules preferably comprise 15-30% of the resultant composition and gums preferably comprise approximately 0 to 5% of the resultant composition. Gelatin preferably comprises 0 to 10% of the resultant composition. Dimethicone is preferably added to a mixture of water, preservatives and the dry-blended mixture following addition of the dry-blended mixture. If desired, ultracel fiber powder may be incorporated into the bulking system after preservatives are added to water but before the dry-blended mixture is added. A first liquid mixture is preferably comprised of Litesse ultra liquid which comprises approximately 0 to 5% of the resultant composition and clarified rice syrup which comprises approximately 0-3% of the resultant composition. Clarified rice syrup may preferably be incorporated into the bulking system as a binding agent when gelatin and/or pectin are absent from the bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry Bell and Blue Raspberry/Bell) and sucralose. Acids comprise approximately 1-3% of the resultant bulking system, and the remaining components of the second liquid mixture comprise approximately 1-2% of the resultant composition. Again, other than alterations to the composition of the dry-blended and liquid mixtures as described, the process of forming the bulking system with respect to this embodiment of the present invention proceeds in the manner described above with respect to the first embodiment. In the present embodiment, calcium lactate is not used as an activator; however, it should be appreciated that an activator could preferably be incorporated into the formulation without departing from the objects of the present invention. Again, variations of the above-described embodiment may be formed by adding other active ingredients, plasticizing agents or HSH. The dry-blended mixture as well as the first and second liquid mixtures remain at the same percentages of the resultant soft candy composition even with addition of any or all of the above-described additional ingredients.

In a fourth embodiment of the present invention, a soft candy product is formed containing no Litesse in the formulation. Erithritol, gellan gum LT100, gellan gum F/Kelco gel, carageenan iota, and gum Arabic/colony are combined to form a dry-blended mixture. Erithritol granules preferably comprise approximately 9-30% of the resultant composition and gums preferably comprise approximately 0 to 5% of the resultant composition. A first liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 2-3% of the resultant bulking system, and the remaining components of the second liquid mixture comprise approximately 1-2% of the resultant composition.

Preservatives (such as Glass H and potassium sorbate) are added to water in the mixing tank and then dissolved under low agitation without heat. These preservatives preferably form approximately 0.1% of the resulting composition. The dry-blended mixture is preferably added to the preservative/water mixture under high shear/agitation and blended until no lumps are visible. This blending process preferably continues for approximately 10-15 minutes depending on the volume of the mixture. Heat may then be applied once the dry-blended mixture is added, and the mixture may preferably be heated to a first temperature of at least 190 degrees Fahrenheit.

A first liquid mixture of acids, flavor, sucralose, fruit concentrate and color is then preferably added under medium high agitation. It should be appreciated that the mixture will undergo some thinning in texture. Agitation of the mixture should preferably continue until the temperature of the mixture reaches a predetermined temperature range of approximately 200-220 degrees Fahrenheit. When this predetermined temperature range has been reached, the composition that forms is held for later panning or molding. It should be appreciated that the resultant composition may have a less smooth texture than other embodiments, and thus, it may be desirable to run the resultant composition through a hydrocolloid mill or an extruder in order to smooth out the texture, particularly if it is desirable to have a finished product such as licorice or an extruded snack bar.

In a fifth embodiment of the present invention, a soft candy product is formed. In this formulation, several modifications are made in comparison to the previously described embodiments. For example, a combination of gums, including gellan gum LT100 and gellan gum F/Kelco gel as well as xanthan gum/ISP, is used. An ultracel coarse fiber powder also is incorporated into the bulking system. Further, bees wax forms a part of the bulking system. Erithritol, gelatin type A 250 bloom, gellan gum LT100, gellan gum F Kelco gel, and xanthan glum/ISP are combined to form a dry-blended mixture. Erithritol granules preferably comprise approximately 9-30% of the resultant composition, pectin preferably comprises approximately 1-2% of the resultant composition, and gums preferably comprise approximately 0 to 5% of the resultant composition. Dimethicone is preferably added to a mixture of water, preservatives and the dry-blended mixture following addition of the dry-blended mixture. If desired, ultracel fiber powder may be incorporated into the bulking system after preservatives are added to water but before the dry-blended mixture is added. A first liquid mixture is preferably comprised of Litesse ultra liquid which comprises approximately 8-10% of the resultant composition and clarified rice syrup which comprises approximately 0-3% of the resultant composition. Clarified rice syrup may preferably be incorporated into the bulking system as a binding agent when gelatin and/or pectin are absent from the bulking system. In an intermediate step, a wax, such as bees wax, may be added separately to the mixture following addition of the first liquid mixture. A second liquid mixture is prepared comprising ascorbic acid, malic acid, fumaric acid, sodium acid sulfate (pHase), fruit concentrate (such as fruit concentrate Pear/essence returned), colors (such as blue # 1 lake), flavors (such as Strawberry/Bell and Blue Raspberry/Bell) and sucralose. Acids comprise approximately 2-3% of the resultant bulking system, and the remaining components of the second liquid mixture comprise approximately 1-2% of the resultant composition.

While several embodiments have been described above, it should be appreciated that these embodiments are merely representative of the different formulations contemplated as part of the present invention. Other formulations can be made using different combinations and percentages of the components described without departing from the objects of the present invention. It should be appreciated however that textural differences may occur depending on the composition of the bulking system.

While many of the embodiments described include malic acid as part of the second liquid mixture, it should be appreciated that lactic acid may be substituted for malic acid without appreciably changing the percent composition of the resultant bulking system. Lactic acid is preferably used when the bulking system is to have a brown flavor, meaning that the flavor has been typically derived from two basic thermal processes: caramelization and Maillard reactions. Brown flavors include, hut are not limited to, chocolate, vanilla, toffee, mocha, cream/milk, cinnamon and caramel. If lactic acid is preferably used as part of the formulation of the bulking system, it should be appreciated that the colors and flavors incorporated into the second liquid mixture will be altered as fruit concentrate typically would not be utilized when a brown flavor is desired. In an embodiment of the present invention, a chocolate candy may preferably be formed using the bulking system through addition of a form of cocoa (cocoa butter, cocoa solid, cocoa liquor or combinations thereof) along with nonfat milk or cream and optionally additional emulsifiers such as lecithin and/or proteins including, but not limited to, whey protein, soy protein and/or milk protein concentrate, in order to keep the oils together. Other acids including but not limited to glucona delta lactone (GDL), adiptic acid and phosphoric acid may be used in combination with lactic acid without departing from the objects of the present invention. While more calories may be added to the bulking system to form a chocolate-flavored version, there is still no sugar added and accordingly no laxative effect is felt from ingestion.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A low-calorie, no laxation bulking system, said bulking system comprising:
a dry-blended mixture, said dry-blended mixture comprising at least 9 to 50% erithritol, and 0 to 5% gums;
a first liquid mixture, said first liquid mixture comprising 0 to 20% modified polydextrose; and
a second liquid mixture, said second liquid mixture comprising 0 to 5% acid;
wherein said dry-blended mixture, said first liquid mixture and said second liquid mixture are combined.

2. The bulking system of claim 1, said second liquid mixture further comprising:
0 to 3% flavor:
0 to 5% sucralose; and
0 to 15% fruit puree concentrate with essence returned.

3. The bulking system of claim 1 said dry-blended mixture further comprising:
0 to 5% low methoxal pectin.

4. The bulking system of claim 1, said bulking system further comprising:
0 to 4% hydrogenated starch hydrolysate (HSH).

5. The bulking system of claim 1, said bulking system further comprising:
0 to 7% of at least one active ingredient.

6. The bulking system of claim 1, said hulking system further comprising:
at least one preservative.

7. The hulking system of claim 1 said bulking system further comprising:
a food-grade plasticizing agent selected from the group comprising: paraffin wax, carnuba wax, bees wax, food-grade resins, and food-grade gums.

8. The bulking system of claim 1, said bulking system further comprising:
at least one activator.

9. The bulking system of claim 1, said gums selected from the group comprising:
gellan gums, carrageenan iota gum, carrageenan, gum arabic, xantham gum, karaya gum, agar, locust bean/carob bean, carboxy methyl cellulose (CMC) and tragancanth.

10. The bulking system of claim 1, wherein said bulking system is selected from the group comprising:
soft candy products, hard candy products, hard candy coated products, low-calorie gummy-like products, non-rolled fruit snacks, gummy-like products loaded with vitamins, energy-producing gummy-like products, gummy-like products for weight loss, chocolate chews, fruit extruded bar or rope/twist, hard candies, bars, licorice ropes or analogs, fruit snacks, and rolled fruit snacks.

11. A method for producing a low-calorie, no laxation bulking system, said method comprising:
blending a first set of ingredients comprising erithritol and at least one gum to form a dry-blended mixture;
blending modified polydextrose to form a first liquid mixture;
adding said dry-blended mixture to water, forming a first mix and heating to a first temperature;
adding said first liquid mixture to said first mix to form a second mix and heating to a second temperature; and
adding a second liquid mixture comprising at least one acid to said second mix to form a moldable mix.

12. The method of claim 11, said method further comprising:
depanning said bulking system into a sealable container; and
introducing nitrogen into said sealable container.

13. The method of claim 11, said method further comprising:
cooling said moldable mix; and
plating said moldable mix.

14. The method of claim 11, said method further comprising:
adding at least one preservative, wherein said at least one preservative is added prior to formation of said first mix.

15. The method of claim 11, said first set of ingredients further comprising:
at least one pectin.

16. The method of claim 11, said method further comprising:
adding at least one active ingredient, wherein said active ingredient is added to the second mix after the second mix has been reduced to said second temperature.

17. The method of claim 11, wherein said second liquid mixture further comprises:
colors, flavors, fruit concentrate, and sucralose.

18. The method of claim 11, said method further comprising:
adding at least one activator.

19. The method of claim 13, said method further comprising:
sanding said moldable mix.

20. A stable hulking system comprising 9 to 50% erithritol, said bulking system comprising:
a dry-blended mixture, said dry-blended mixture comprising erithritol and at least one gum;
a first liquid mixture of modified polydextrose; and
a second liquid mixture, comprising at least one acid;
wherein said dry-blended mixture, said first liquid mixture and said second liquid mixture are combined.
